(19) United States
(12) Patent Application Publication
(10) Pub. No.: US 2026/0149525 A1
(43) Pub. Date: May 28, 2026

(54) A Reconfigurable Optical Add/Drop Multiplexer

(71) Applicant: Telefonaktiebolaget LM Ericsson (publ), Stockholm (SE)

(72) Inventors: Stefano Orsi, Genova (IT); Riccardo Ceccatelli, Genova (IT); Roberto Magri, Genova (IT); Mattia Mezzone, Genova (IT)

(21) Appl. No.: 19/121,607

(22) PCT Filed: Oct. 19, 2022
(86) PCT No.: PCT/EP2022/079149

§ 371 Date: Apr. 16, 2025

(51) Int. Cl. H04J 14/02; H04B 10/80

(52) U.S. Cl. CPC H04J 14/0212; H04B 10/806

(57) ABSTRACT

Embodiments described herein relate to methods and apparatuses for providing a reconfigurable optical add-drop multiplexer, ROADM, (300) for use in an optical network. A ROADM comprises a first port (301a); a second port (302a); a third port (305a); and a first switch (307a) configured to: couple the first port to the second port in a first mode; and to couple the first port to the third port in a second mode, wherein: the third port is configured to be coupled to a first transceiver (306a) of a first network node, and the first switch is configured to utilise power supplied by the first transceiver being on to enter the second mode.

### TECHNICAL FIELD

Embodiments described herein relate to a reconfigurable optical add/drop multiplexer. In particular, embodiments described herein provide for a passive ROADM that may utilize power from a local transceiver at a network node in order to enter a mode of operation in which a wavelength may be added or dropped at the network node.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Reconfigurable Optical Add/Drop Multiplexer (ROADM) based networks utilizing Wavelength Selective Switches (WSS) have been deployed. A WSS has the functionality of de/multiplexing any of the individual wavelengths to selected common or output ports. A WSS may achieve this by dispersing incoming light onto a switching engine that can uniquely address each part of the spectrum. There are various technologies that can be used as a WSS switching engine including MEMS (microelectromechanical systems), LC (liquid crystal) and LCoS (liquid crystal on silicon). The vast number of micro mirrors in MEMS affect its performance stability. Meanwhile, it is hard for MEMS to support high port count (>20) and flexible grid. LC has much better stability. However, the main disadvantage of LC technology arises from the thickness of the stacked switching elements. Keeping the optical beam tightly focused over this depth is difficult and has, so far, limited the ability of high port count WSSs to achieve very fine (12.5 GHz or less) granularity. Therefore, LCoS becomes the most common switching engine for medium to high port counts. Since becoming the majority platform in ROADM networks, the performance of LCoS WSS products has been improved with typically high port isolation and enhanced Flexgrid technology enabled flexible grid functionality, with granularity of spectral assignment being reduced from firstly 12.5 GHz to 6.25 GHz, then further to 3.125 GHz in some applications.

The Information Communication Technology (ICT) ecosystem has been rapidly and dramatically changing in recent years. New multimedia and cloud services, the deployment of the “Internet of things” and the convergence between optical and wireless communications at the 5G paradigm require changes to the networks to enable scalable growth in traffic volume while supporting a high level of dynamic connectivity, full flexibility, and increased energy efficiency. These features may be achieved by considering the cooperation between the network control and data plane in a Software Defined Network (SDN) architecture.

An WSS to be used in the aggregation and access network segments may be required to have low insertion loss. The fronthaul access network segment does not generally include amplifiers.

When establishing a lightpath, all the WSS units along the lightpath must be properly configured before initiating the optical flow transmission. WSS devices take time to be switched and consequently delay the lightpath setup completion time. Typically, 5 seconds is needed for a 40 wavelength single WSS. A ROADM node based on WSS may not be used in a fronthaul access network because there is a constraint not to exceed 100 μs of latency between a remote radio unit and baseband.

For a 4 way WSS unit the typical power consumption is 30 W. In a 4 way ROADM node, 4 WSS units may be needed, one for each direction, so the total power consumption would be 120 W. In a fronthaul scenario where the target is to keep the power consumption as low as possible, 120 W may be a significant power consumption. In addition, backup batteries are expensive, and they occupy space in a central office or on a pole at a remote site.

The ROADM node may usefully comprise “off-the-shelf” components, for example, to improve operation in a cloud Radio Access Network (RAN) architecture with a SDN control plane. The ROADM node may be required to provide a very high Mean Time Between Failures (MTBF) to optimize OPEX in the access/edge network segment. In the edge/access network, the ROADM node may be required to coexist with legacy systems.

### SUMMARY

According to some embodiments there is provided a reconfigurable optical add-drop multiplexer, ROADM, for use in an optical network. The ROADM comprises a first port; a second port; a third port; and a first switch configured to: couple the first port to the second port in a first mode; and to couple the first port to the third port in a second mode, wherein: the third port is configured to be coupled to a first transceiver of a first network node, and the first switch is configured to utilise power supplied by the first transceiver being on to enter the second mode.

According to some embodiments there is provided a method of performing adding or dropping of signals at a reconfigurable optical add/drop multiplexer, ROADM, wherein the ROADM comprises a first port, a second port, a third port and a switch. The method comprises responsive to receiving power at the third port, utilising the power at the switch to couple the first port to the third port.

According to some embodiments there is provided a reconfigurable optical add/drop multiplexer, ROADM. The ROADM comprises a first port, a second port, a third port and processing circuitry, wherein the processing circuitry is configured to cause the ROADM to responsive to receiving power at the third port, utilising the power to couple the first port to the third port.

Aspects and examples of the present disclosure thus provide a ROADM that may be operated passively, thus avoiding the need to provide power to the ROADM and allowing for flexibility in the site positioning of the ROADM.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example of a network comprising a ROADM node according to some embodiments;

FIG. 2 illustrates an example of a network 200 comprises a ROADM node 201 according to some embodiments;

FIG. 3 illustrates a reconfigurable optical add-drop multiplexer, ROADM, 300 for use in an optical network;

FIG. 4 illustrates an example implementation of the ROADM 300 illustrated in FIG. 3:

FIG. 5 illustrates the ROADM of FIG. 4 where the bi-stable switches 407 and 408 are in an add/drop position;

FIG. 6 illustrates an example of the ROADM 300 in which splitters are provided instead of MUX/DEMUX elements;

FIG. 7 illustrates an example of an optical network utilising an 1×5 AWG ROADM;

FIG. 8 illustrates an example in which a 5×1 AWG ROADM may be utilized to perform node protection;

FIG. 9 illustrates an example of a meshed optical network comprising a ROADM 300;

FIG. 10 illustrates a method of performing adding or dropping of signals at a reconfigurable add/drop multiplexer, ROADM, wherein the ROADM comprises a first port, a second port, a third port and a switch;

FIG. 11 illustrates a ROADM 1100 comprising processing circuitry (or logic);

FIG. 12 is a block diagram illustrating an ROADM 1200 according to some embodiments.

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICS, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments described herein propose a ROADM (Reconfigurable Optical Add/Drop Multiplexer) node which may be considered a passive ROADM node. The proposed ROADM node may comprise of two or more multiplexer/demultiplexer modules and a set of switches, also referred to as selection modules (e.g. one for each channel). The proposed ROADM node may be able to switch wavelengths, or perform, on a per channel basis, local adds or drops of wavelengths. It may also be possible to perform wavelength conversion or regeneration at the ROADM node.

Each selection module may comprise an optical switching circuit that is powered only when needed by the optical power introduced by the coupled transceiver at the wavelength to be added/dropped. This avoids the need to otherwise power the ROADM node, which may therefore remain intrinsically passive and may therefore be positioned in a place with no need of power supply units.

When a transceiver coupled to the ROADM is switched on, the light generated will trigger the selection module to drop/add the signal. When the transceiver is switched off the selection module returns to pass-through position. The selection module may be configured to remain in a pass through position if no transceiver is present.

The structure of the proposed ROADM enables the decision as to which wavelengths should be added/dropped to be implemented by exploiting the tunability of the optical transceivers at both terminal nodes and on the ROADM sites.

The combination of the selection module with different types of multiplexer/demultiplexer makes the proposed ROADM node flexible to be used in different scenarios and applications.

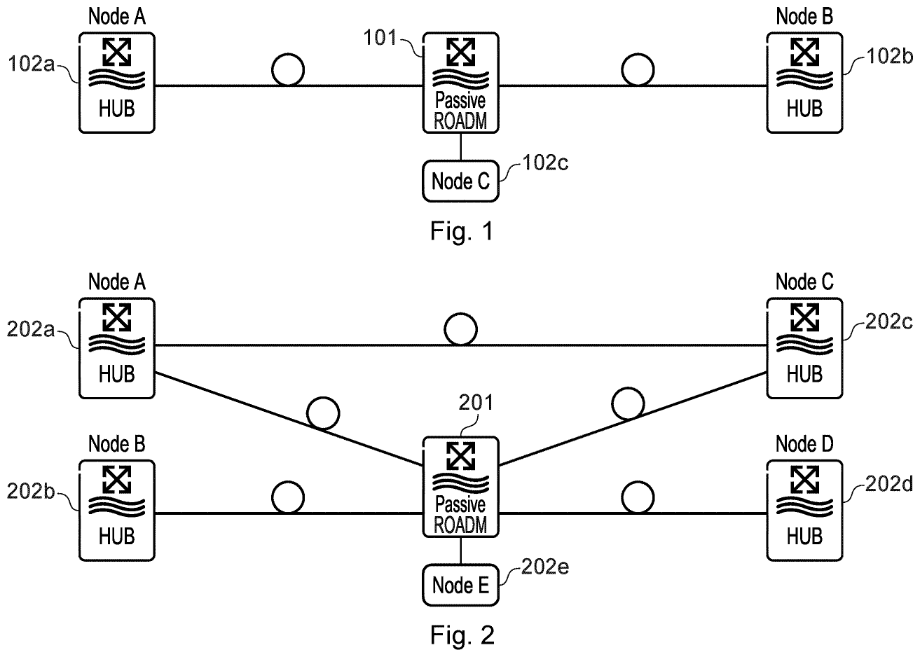

A ROADM node according to embodiments described herein may be implemented in an optical network such as that illustrated in FIG. 1 or FIG. 2.

FIG. 1 illustrates an example of a network comprising a ROADM node according to some embodiments. In particular, FIG. 1 illustrates a 2-way ROADM node 101.

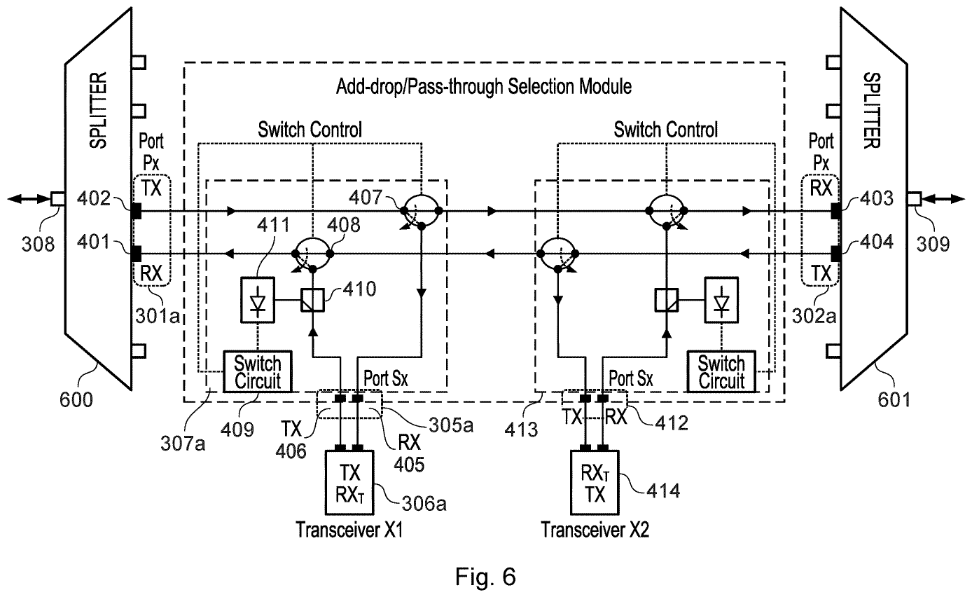

The network 100 comprises a first network node 102a, a second network node 102b and a third network node 102c connected via the 2-way ROADM node 101. The two-way ROADM node 101 may therefore add or drop different frequencies at the third network node 102c. The functionality of such a 2-way ROADM node will be described in more detail with reference to FIG. 6.

FIG. 2 illustrates an example of a network 200 comprises a ROADM node 201 according to some embodiments. In particular, FIG. 2 illustrates a multi-way ROADM node 201.

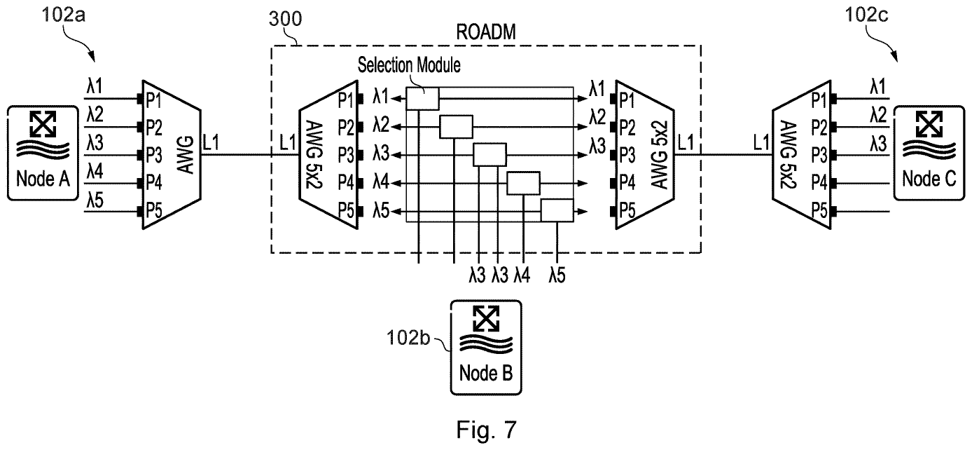

The network 200 comprises a meshed optical network, which interconnects different Hub nodes (Node 202a to 202d) a ROADM node 201 is inserted at Node E 202e to modulate, when necessary, the traffic from node 202a to node 202c and 202d or from node 202b and nodes 202c and 202d or also to an intermediate node 202e. The functionality of an example multiway ROADM node will be described in more detail with reference to FIG. 7.

The above referenced example networks illustrated in FIGS. 1 and 2, of course, are only examples and they can be further complicated (e.g. with more ROADM Nodes) or reduced, according to the actual switching capability required by the optical network.

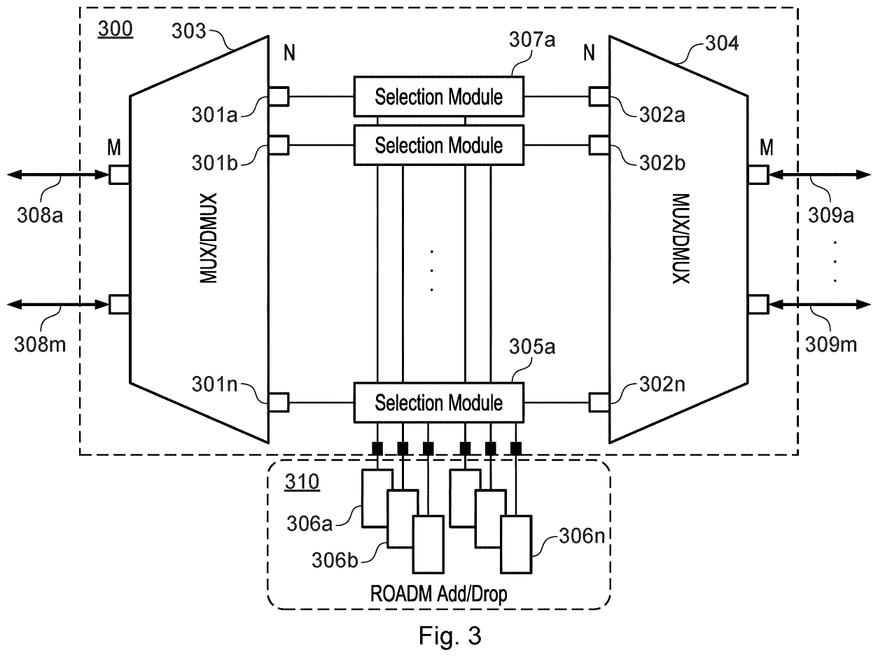

FIG. 3 illustrates a reconfigurable optical add-drop multiplexer, ROADM, 300 for use in an optical network.

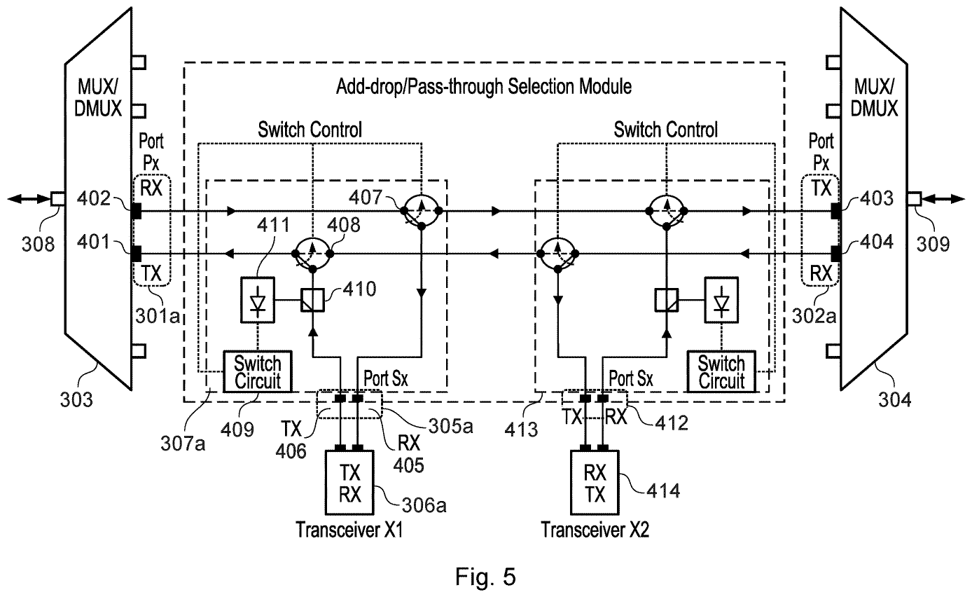

The ROADM 300 comprises a first port 301a. The first port 301a may be one of a plurality of first ports 301a to 301n which are the client ports of a first multiplexer/demultiplexer (MUX/DEMUX) 303. In some examples, the first MUX/DEMUX 303 comprises a splitter as will be described in more detail with reference to FIG. 5.

The ROADM 300 further comprises a second port 302a. The second port 302a may be one of a plurality of second ports 302a to 302n which are the client ports of a second MUX/DEMUX element 304.

The ROADM 300 comprises a third port 305a. The third port 305a may comprise one of more third ports 305a to 305n coupled to a network node 310. In particular, the ROADM 300 may be coupled to a network node 310 at which the ROADM may add/drop wavelengths depending on its mode of operation. The network node 310 may comprise one or more transceivers 306a to 306n configured to receive or transmit the added/dropped wavelengths.

The ROADM 300 further comprises a first switch (or selection module) 307a is configured to couple the first port 301a to the second port 302a in a first mode; and to couple the first port 301a to the third port 305a in a second mode.

For example, as the third port 305a may be configured to couple to a first transceiver 305a of a first network node 310, the first selection module 307a may then be configured to utilize power supplied by the first transceiver being on to enter the second mode. For example, the first selection module may comprise one or more bi-stable switches configured to utilise the power supplied by the first transceiver in order to switch between the modes of operation. The selection module 307a may comprise switching circuitry powered by the optical power of the local transceiver and including a logic that commutes the position of one or more bi-stable switches depending on the presence or absence of said optical power.

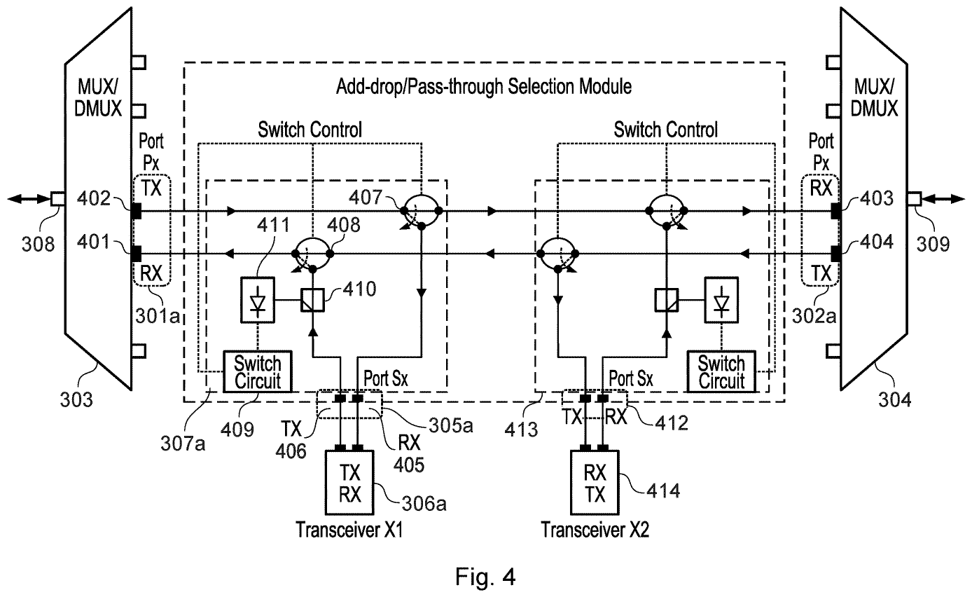

In other words, when the first transceiver is turned on, the first selection module 307a connects the first port 301a to the first transceiver 306a via the third port 305a. The functionality of a first selection module 304a will be described in more detail with reference to FIGS. 4 and 5.

It will be appreciated that the MUX/DEMUX elements 303 and 304 may comprise passive elements for example AWGs, N×M AWGs, splitters or Thin Film Filter (TFF). The MUX/DEMUX elements 303 and 304 may be positioned back-to-back coupled by a set of selection modules 307a to 307n. The selection modules 307a to 307n may then connect the MUX/DEMUX elements 303 and 304 to the local transceivers 305a to 305n at the network node 310.

For example, a first multiplexer/demultiplexer, MUX/DEMUX, module 303 may be configured to multiplex signals received at a plurality of first ports 301a to 301n comprising the first port 301a. The second MUX/DEMUX 304 may be configured to multiplex signals received at a plurality of second ports 302a to 302n.

The first MUX/DEMUX 303 may be configured to demultiplex signals received at one or more fifth ports 308a to 308m for transmission over the first plurality of ports 301a to 301n. The second MUX/DEMUX 308 may be configured to demultiplex signals received at one or more sixth ports 309a to 309m for transmission over the second plurality of ports 302a to 302n.

It will be appreciated that each selection module 307a to 307n may be coupled between a respective first port at the first MUX/DEMUX 303 and a respective second port at the second MUX/DEMUX 304. Each selection module 307a to 307n may then be configured to selectively couple the first and second ports to respective local transceivers 305a to 305n.

For example, each selection module 307a to 307n may operate in a first mode when the respective local transceiver is either switched off, or not present, wherein in the first mode the selection module couples the first MUX/DEMUX and the second MUX/DEMUX together.

Each selection module 307a to 307n may also operate in a second mode when the respective local transceiver is switched on, wherein in the second mode the selection module 307a to 307n couples the first MUX/DEMUX 303 and the local transceiver 305i. The selection module 307a to 307n may alternatively be referred to as a switch or switch circuitry.

In some examples, the selection modules 307a to 307n coupled between the first MUX/DEMUX element and the second MUX/DEMUX element may be duplicated. In other words, the selection modules 307a to 307n may be considered to address one side of the ROADM as they may be configured to selectively couple the first MUX/DEMUX to the local transceivers at the network node 310. However, one or more second selection modules (not illustrated) may also be provided to selectively couple the second MUX/DEMUX 304 the local transceivers at the network node 310.

The number of line ports (e.g. the one or more fifth ports or one or more sixth ports) and client ports (e.g. the first plurality of ports or the second plurality of ports) of the MUX/DEMUX elements 303 and 304 may be adjusted according to the network application that is being addressed. For example, for a 2-way ROADM only two line ports are required. Furthermore, the number of client ports at each MUX/DEMUX may be tailored according to the maximum add/drop capability provided by the ROADM node.

In some examples, as will be described in more detail with reference to FIG. 6, the ROADM node may comprise splitters instead of the MUX/DEMUX elements. A plurality of tuneable filters may then be provided at the local transceivers (e.g. at each receiver port, for example, port 405) and at the ROADM sites (e.g. at the 406 through which the ROADM receives signals transmitted by the transceiver).

There is no processing function in the ROADM 300 as described with reference to FIG. 3, which therefore lends itself to being used in a network characterized by a separation between software and hardware with an SDN (Software Defined Networking) controller.

FIG. 4 illustrates an example implementation of the ROADM 300 illustrated in FIG. 3.

In particular, FIG. 4 illustrates components required to realize the add-drop/pass-through “switching” functionality on a passive ROADM, making it a ROADM (i.e. Reconfigurable).

FIG. 4 illustrates the following elements on FIG. 3 in more detail: a first port 301a, a second port 302a, a third port 305a and a switching module (or switch) 307a. It will be appreciated that only one connection between a first port 301a and a second port 302a is illustrated for clarity. The other ports at the MUX/DEMUX elements 303 and 304 may be connected via one or more switching modules in a similar manner.

In particular, it can be seen that the first port 301a may comprise a first receiver port 401 and a first transmitter port 402. Similarly, the second port 302a comprises a second receiver port 403 and a second transmitter port 404. The third port 305a comprises a third receiver port 405 and a third transmitter port 406.

In this example, the first selection module 307a comprises a first bi-stable switch 407 which in the first mode couples the first transmitter port 402 and the second receiver port 403.

In this example, the first selection module 307a further comprises a second bi-stable switch 408 which in the first mode couples the first receiver port 401 and the second transmitter port 404.

The first selection module 307a further comprises switching circuitry 409 configured to: responsive to the first transceiver 306a being turned on, provide power to switch the first bi-stable switch 407 to couple the first transmitter port 402 and the third receiver port 405. The switching circuitry 409 may alternatively be referred to as a switch circuit.

Responsive to the first transceiver 306a being turned on the switching circuitry 409 may be configured to provide power to switch the second bi-stable switch 408 to couple the first receiver port 401 and the third transmitter port 406.

In other words, the selection to the add/drop wavelengths at the network node 310 is made possible due to the one or more bi-stable switches per port (e.g. 301a, 302a and 305a). There may be one bi-stable switch for the Tx direction and the one bi-stable switch for the Rx direction. These bi-stable switches may normally be in a pass-through position (as illustrated in FIG. 4).

FIG. 5 illustrates the ROADM of FIG. 4 where the bi-stable switches 407 and 408 are in an add/drop position.

These bi-stable switches 408 and 407 obtain the needed power to commutate into the add-drop position illustrated in FIG. 5 directly from the transceiver 306a. For example, once the transceiver 306a is intentionally switched on by the operator via a Network Management System, the bi-stable switches 408 and 407 may automatically switch connections into the add-drop position.

The energy required by each bi-stable switch 408 and 407 for the switch in connection may be provided by the optical power of the transceiver 306a itself, for example, by the power of the transmitter laser in the transceiver 306a.

For example, as illustrated in FIGS. 4 and 5, the power of the transmitter laser in the transceiver 306a may be split by a splitter 410 to provide a small portion to feed, through a suitable photodetector 411, the switching circuitry 409. The photodetector is configured to convert optical energy into electrical energy. The photodetector 411 is configured to receive optical power and convert the optical power into electrical power. For example, the photodetector 411 is a photodiode. The transceiver is configured to generate one or more optical wavelengths for optical transmission of a signal. The electrical power derived from the optical signal is used to power the switches (i.e. selection module) of the ROADM. The switches providing for selection of a wavelength to be added, dropped or passed-through may be bi-stable, in order to reduce energy consumption.

Consider that the transmitter laser of the transceiver 306a provides 0 dBm; supposing that the distance from the transceiver 306a to the Passive ROADM 300 is 100 meters, and that the patch-cord loss and coupling losses (assuming a splitter ratio of 20%) which gives only a 1 dB penalty on the main path, even with a conservative estimate, one may assume to have −8 dBm (i.e. 0.16 mW of optical power) at the photodetector 411.

Assuming a conversion efficiency of 65%, this would provide 0.1 mW of electrical power. This electrical power, continuously provided by the photodetector 411, may be stored in an accumulator (e.g. a capacitor or a rechargeable battery) in the switching circuitry 409. Thus, the electrical power obtained from the optical signal is stored.

For example, the accumulator may be configured to charge whilst power is supplied at the third port. At this example rate, the accumulator may accumulate an energy of 10 mJ in 100 seconds (e.g. less than 2 minutes). This amount of energy may be enough to switch on a circuit of 100 mW for 100 ms.

This above example demonstrates the feasibility of the bistable switches 407 and 408 for switching between the first mode and the second mode of operation. However, the actual dimensioning of such circuitry can vary case by case, depending on the actual power of the Tx Laser, the length of the interconnection (from transceiver to the ROADM), and the time considered acceptable between when the transceiver is switched on by the NMS and the time when the switching actually occurs.

It will be appreciated that the switching circuitry 409 may be configured to be responsive to the first transceiver 306a being switched off. For example, the switching circuitry is configured to provide power from the accumulator to switch the first bi-stable switch to couple the first transmitter port and the second receiver port; and provide power from the accumulator to switch the second bi-stable switch to couple the first receiver port and the second transmitter port.

In other words, to switch back to the pass-through condition, once the transceiver is switched-off (e.g. by the NMS system), the photodetector 411 may detect a loss condition. The switch has accumulated enough power to switch to a pass-through state (e.g. the first mode of operation) for both switches, on the Tx and Rx paths. As such, the photodetector 411 is configured to both generate electrical power when the transceiver is switched on, and control the switching based on detecting the transceiver is switched on or off.

In some aspects, the photodetector 411 has two functions. Firstly, the photodetector 411 is configured to convert optical power to electrical power, which can be stored and used to set the configuration of the selection module. Secondly, the photodetector 411 is used as a sensor to detect the addition or ceasing of an optical signal, e.g. an optical signal to be added at the ROADM. As such, the photodetector 411 is used as a trigger to initiate control of the switch configuration of the ROADM. The switching circuitry 409 determines whether the first transceiver 306a (e.g. at an ADD port) is turned on or off from an output level of the photodetector 411. The switching circuitry 409 is configured to set the selection module to connect the first transceiver 306a, e.g. to the MUX/DEMUX 303,304, when an optical signal is transmitted by (or to) the first transceiver 306a. The switching circuitry 409 is configured to set the selection module to disconnect the first transceiver 306a, e.g. from the MUX/DEMUX 303,304, when an optical signal is no longer transmitted by (or to) the first transceiver 306a. A corresponding function applies to the other transceivers.

By implementing this selection module structure (i.e. a plurality of switches) between every connection between the first ports 301 of the first MUX/DEMUX 303 and the second ports 302 of the second MUX/DEMUX 304, any of the N client ports of the ROADM 300 may be switched from pass-through to add-drop if required by the operator by switching on the relevant transceiver tuned at the desired wavelength. As such, a separate control signalling is not required. Once the transceiver is turned-off again, the energy is no more present, and the bistable switches revert to their original “pass-through” position.

This mechanism means that no power needs to be provided to the ROADM because the necessary energy is provided by the transceivers themselves when switched on. The power is therefore only provided when necessary. In some examples, the switching does not require control signaling, the switching (i.e. optical connections made) is based only on the presence of an optical signal.

The ROADM 300 may further comprise a fourth port 412 and a second switch (i.e. selection module) 413 configured to couple the first port 301a to the second port 302a in a third mode and the second port 302a to the fourth port 412 in a fourth mode.

The fourth port 412 is configured to be coupled to a second transceiver 414 of the first network node. The second switch (i.e. selection module 413) is configured to utilize power supplied by the second transceiver 414 being on to enter the fourth mode. In other words, the second selection module 413 is configured to provide the same add/drop mechanism for the second MUX/DEMUX 304 as the first selection module 307a does for the first MUX/DEMUX 303.

It will be appreciated that the second switch (selection module) 413 may comprise similar features to that of the first switch (selection module) 307a as illustrated in FIGS. 4 and 5.

FIG. 6 illustrates an example of the ROADM 300 in which splitters are provided instead of MUX/DEMUX elements.

In this example, the ROADM comprises a first splitter 600 and a second splitter 601. In this example, a tuneable filter is added to each transceiver at the terminal and ROADM sites in order to select the desired wavelength.

Bu utilising the first splitter 600 and the second splitter 601 instead of the MUX/DEMUX elements, the example of FIG. 6 does not allow for the selection the wavelength that is allocated to each transceiver which therefore receives all the wavelengths on the line. The tuneable filters coupled to the receiver ports of each transceiver allows for the selection of the desired wavelength.

Many possible combinations of optical network topologies can be realized using the passive ROADM building block described above.

FIG. 7 illustrates an example of an optical network utilising an 1×5 AWG ROADM. This example illustrates a more detailed view of the simple end-to-to end link illustrated in FIG. 1. The ROADM 300 may comprise a ROADM 300 as illustrated in any one of FIGS. 4 to 6.

In this example, two wavelengths (λ₁ and λ₂) flow end to end from node 102a to node 102c. To achieve this, the selection modules positioned between the ports P1 and the ports P2 may be configured in the first mode of operation (e.g. the pass through mode) such that the wavelengths are transmitted between the node 102a and the node 102c.

In this example, two wavelengths are terminated in the node 102b (λ₄ and λ₅). To do this the transceivers in node 102b that are coupled to the selection modules positioned between ports P4 and the ports P5 are turned on such that the relevant selection modules are switched to operate in the second mode. In this second mode the switches are commuted such that the wavelengths λ₄ and λ₅ are dropped at the node 102b.

In this example, one wavelength (λ₃) is regenerated at node 102b or alternatively terminated at node 102b and retransmitted from node 102b to node 102c. To do this a second transceiver is coupled to a second selection module that is coupled between the ports P3. This second selection module selectively couples the second MUX/DEMUX 304 to the transceiver, and may therefore be effectively used to “reuse” the wavelength λ₃ between the node 102b and the node 102c. Such a regeneration of a wavelength at an intermediate node may effectively improve the link budget.

The decision as to which wavelengths at node 102b are to be passed through, regenerated or reused may be implemented by switching on/off the relevant transceiver(s) at node 102b. The ROADM element 300 remains “passive”. In some examples, the ROADM may be co-located with node 102b, but also put in a slightly remote passive location (e.g. a passive optical switch intermediate site). Node 102b and node 102c may comprise baseband hotels on which it is possible to perform load sharing of mobile traffic coming from Radio Unit equipment in node 102a.

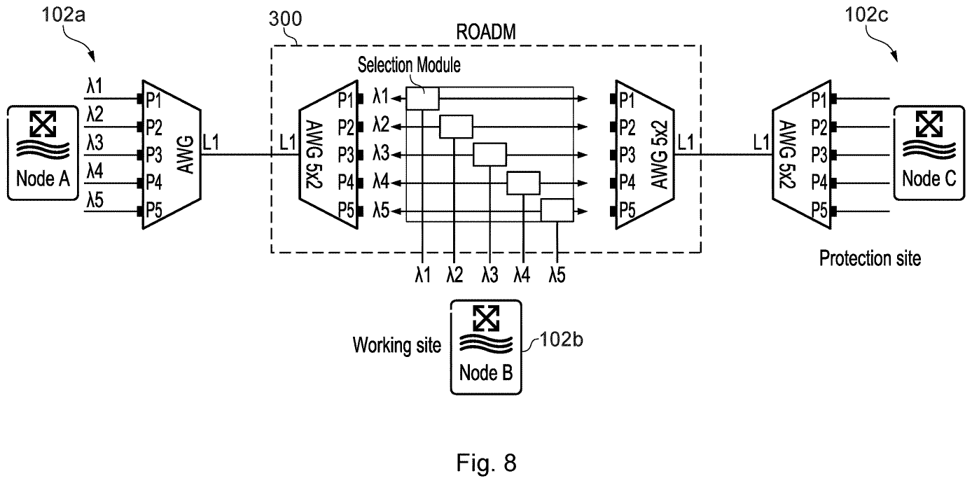

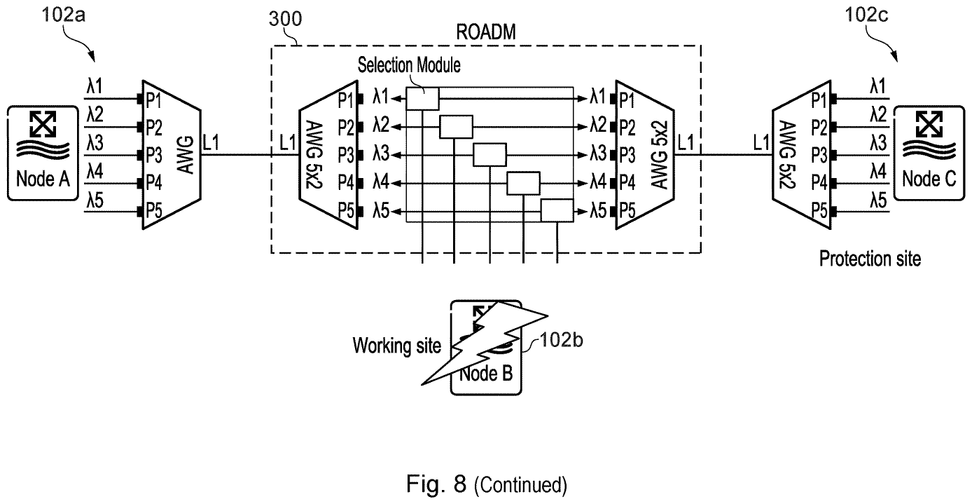

FIG. 8 illustrates an example in which a 5×1 AWG ROADM (i.e. 5 client ports and 1 line port) may be utilized to perform node protection. This example illustrates a use of the simple end-to-end link illustrated in FIG. 1.

In this example, the node 102b is protected by node 102c. The normal working operation would be to have all transceivers on in the node 102b which causes all of the wavelengths (λ₁-λ₅) to be dropped at the node 102b.

However, if a fault should occur in any single transceiver in the node 102b, or indeed a full failure of the node 102b (e.g. the node power fails), the passive ROADM switches the selection modules coupled to any affected transceivers to operate in the first mode of operation (e.g. the pass through mode), and the traffic is restored to the node 102c in a very short time.

It will be appreciated that the passive ROADM 300 may support more than two ways so to have multiple node protection or multiple sites such as node A for which to manage traffic.

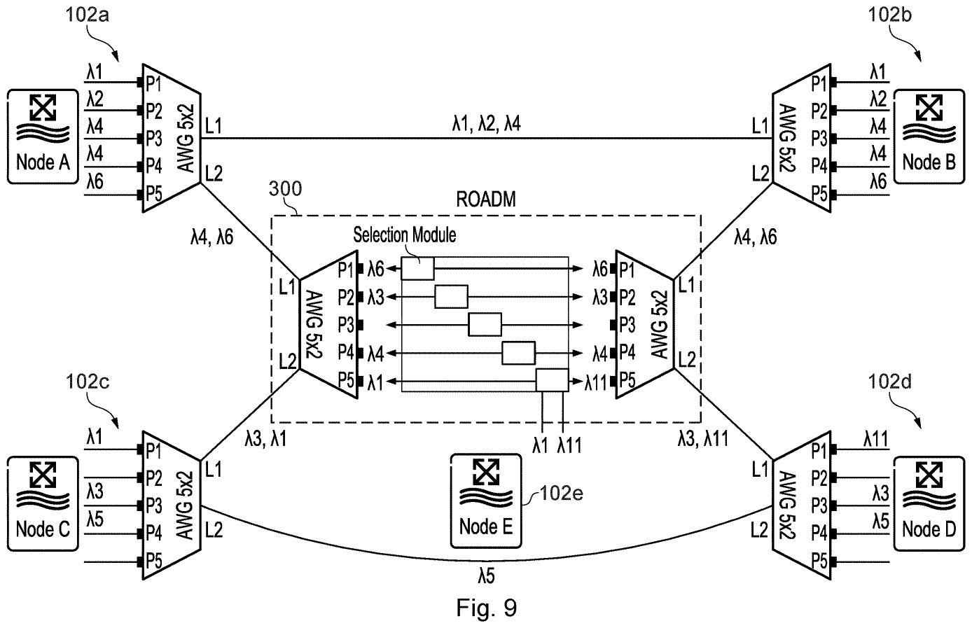

FIG. 9 illustrates an example of a meshed optical network comprising a ROADM 300.

In this example, the ROADM comprises a multiple-ways ROADM where the first and second MUX/DEMUX elements comprise N×M AWGs. In this example N=5 (e.g. 5 client ports) and M=2 (e.g. 2 line ports).

In this example, the meshed network comprises 5 network nodes: nodes 102a to 102e. The node 102e is coupled to all of the other nodes via the ROADM 300.

Some of the nodes are also directly coupled to each other out of one of their line ports. For example, node 102a is coupled directly to node 102b via line port L1 on both nodes. These nodes are also coupled to each other through the line port L2 via the ROADM.

At node 102a the client ports P1 to P5 receive the wavelengths λ₁, λ₂, λ₄, λ₄ and λ₆. Two line ports then multiplex these different signals together such that the wavelengths λ₁, λ₂ and λ₄ are provided at L1, and λ₄ and λ₆ are provided at L2. This illustrates how the same wavelength (in this case λ₄) can be reused if it is transmitted on to different line ports.

In this example, the ROADM 300 is also used to switch wavelengths. Switching on/off a transceiver on node 102e and tuning the transmitter onto a specific wavelength (e.g. onto λ₁₁), it is possible to add/drop that wavelength and change it to another one. For example, λ₁ is changed to λ₁₁ at node 102e. This may alter the end-to-end path or to increase/reduce traffic load on node 102e at different times of the day or of the week.

The advantage is also that the only thing that is required is to switch on/off the relevant transceiver and/or to tune the laser at the wanted wavelength. A further implicit advantage is that, when a service is not required, the transceiver is switched off and therefore does not consume energy.

Currently, silica-based AWG MUX/DEMUX elements are available with standard specifications of, e.g., 40 channels or more, 50-, 100-, or 200-GHz channel spacing and less than 4-dB insertion loss. Large N×M AWGs are also becoming commercially obtainable. A 42×42 AWG provides a worst-case insertion loss less than 4.2 dB. Considering that the selection module according to embodiments described herein will introduce less than 1 dB insertion loss when the transceiver is switched on, the total insertion loss for an ROADM comprising an AWG and a selection module is less than 4-5 dB. In the example of a point-to-point link with a passive ROADM according to embodiments described herein being used as an intermediate site, with terminal nodes being realized with AWG, the total estimated insertion loss for filters is less than 18 dB. Therefore, in a fronthaul network segment there is the possibility to support 10-15 km span on G.652 fiber with 10 G, 25 G, 100 G optics.

The latency introduced to the light path by a ROADM according to embodiments described herein depends on the type of MUX/DEMUX elements used to implement the ROADM itself, but in general it may be considered negligible. An AWG, for instance, provides about 20 ns contribution to latency of the light path. In case of fronthaul application, 100 μs latency is the current constraint for evolved Common Public Radio Interface (eCPRI) mobile traffic between a radio unit and a baseband unit.

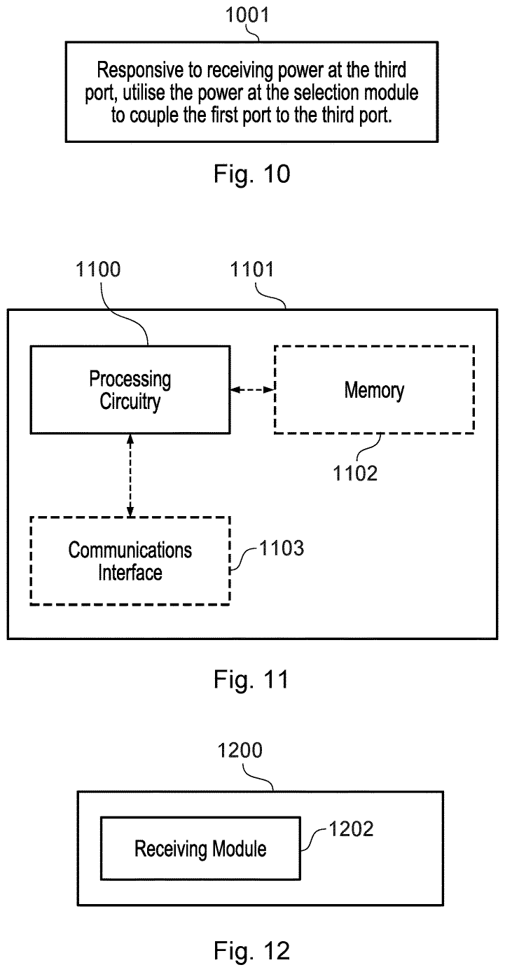

FIG. 10 illustrates a method of performing adding or dropping of signals at a reconfigurable add/drop multiplexer, ROADM, wherein the ROADM comprises a first port, a second port, a third port and a selection module.

The method 1000 may be performed by a network node, which may comprise a physical or virtual node, and may be implemented in a computing device or server apparatus and/or in a virtualized environment, for example in a cloud, edge cloud or fog deployment.

It will be appreciated that the method 1000 may be performed by a ROADM 300 as described herein.

In step 1001 the method comprises, responsive to receiving power at the third port, utilising the power at the selection module to couple the first port to the third port.

For example, step 1001 may comprise switching a bi-stable switch in the selection module from a first position in which the first port is coupled to the second port to a second position in which the first port is coupled to the third port.

The method may further comprise, responsive to receiving power at the third port, charging an accumulator (for example a rechargeable battery or a capacitor) in the selection module with the power.

In some examples, responsive to power not being received at the third port, the method comprises using the power stored at the accumulator to couple the first port to the second port. For example, the method may comprise coupling the first port to the second port by switching the bi-stable switch from the second position into the first position.

FIG. 11 illustrates a ROADM 1100 comprising processing circuitry (or logic) 1101. The processing circuitry 1101 controls the operation of the ROADM 1100 and can implement the method described herein in relation to a ROADM 1100. The processing circuitry 1101 can comprise one or more processors, processing units, multi-core processors or modules that are configured or programmed to control the ROADM 1100 in the manner described herein. In particular implementations, the processing circuitry 1101 can comprise a plurality of software and/or hardware modules that are each configured to perform, or are for performing, individual or multiple steps of the method described herein in relation to the ROADM 1100.

Briefly, the processing circuitry 1101 of the ROADM 1100 is configured to cause the ROADM to: responsive to receiving power at the third port, utilising the power to couple the first port to the third port.

In some embodiments, the ROADM 1100 may optionally comprise a communications interface 1102. The communications interface 1102 may comprise a first port, a second port and a third port. The communications interface 1102 of the ROADM 1100 can be for use in communicating with other nodes, such as other virtual nodes. For example, the communications interface 1102 of the ROADM 1100 can be configured to transmit to and/or receive from other nodes requests, resources, information, data, signals, or similar. The processing circuitry 1101 of ROADM 1100 may be configured to control the communications interface 1102 of the ROADM 1100 to transmit to and/or receive from other nodes requests, resources, information, data, signals, or similar.

Optionally, the ROADM 1100 may comprise a memory 1103. In some embodiments, the memory 1103 of the ROADM 1100 can be configured to store program code that can be executed by the processing circuitry 1101 of the ROADM 1100 to perform the method described herein in relation to the ROADM 1100. Alternatively or in addition, the memory 1103 of the ROADM 1100, can be configured to store any requests, resources, information, data, signals, or similar that are described herein. The processing circuitry 1101 of the ROADM 1100 may be configured to control the memory 1103 of the ROADM 1100 to store any requests, resources, information, data, signals, or similar that are described herein.

FIG. 12 is a block diagram illustrating a ROADM 1200 according to some embodiments. The ROADM 1200 further comprises a first port, a second port and a third port. The ROADM 1200 comprises a receiving module 1202 configured to responsive to receiving power at the third port, utilising the power to couple the first port to the third port. The ROADM 1200 may operate in the manner described herein in respect of a ROADM.

The embodiments described herein provide a ROADM that provides optical switching flexibility suitable for network segments in which there are many constraints to meet. In a fronthaul network segment, for instance, low insertion loss, low latency, low cost, and low power consumption are essential.

The embodiments described herein also provide a ROADM that has a simple architecture—it may, for example, comprise of two or more passive (de)multiplexers in back-to-back and an array of selection modules between them. This simple architecture also comprises very low-cost components and simple circuitry. For example, the proposed ROADM may comprise two of bi-stable switches for each port, and it does not require batteries or external powering.

The proposed ROADM is also possible to control from a management system or a SDN controller in a remote site as the activation or deactivation of the selection module(s) is performed just by switching on or switching off the local transceivers.

The proposed ROADM can support multiple ways. In this case, a flexible optical connectivity is provided by the tunability of the transceiver both at the transceivers and at the ROADM sites. The selection module(s) may further increase the flexibility by introducing automatic wavelength conversion useful for on-the-fly restoration. The selection modules (switches) may also allow for wavelength regeneration to increase the feasibility of the optical connection.

The proposed ROADM is suitable for single fiber working applications. The proposed ROADM is also low loss (e.g. with AWGs), and supports radio access even with no amplification.

The proposed ROADM is a “COTS” (Commercial Off-The-Shelf) product and may be bought “as is”. It can interwork/coexist with legacy WSS, tunable filters, and PON in all network segments.

The benefits of COTS products comprise:
A faster design cycle
Less expensive hardware
Lower maintenance costs

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1.-25. (canceled)

26. A reconfigurable optical add-drop multiplexer (ROADM) for use in an optical network, the ROADM comprising:
a first port;
a second port;
a third port configured to be coupled to a first transceiver of a first network node; and
a first switch configured to:
couple the first port to the second port in a first mode and couple the first port to the third port in a second mode; and
utilize power supplied by the first transceiver to enter the second mode.

27. The ROADM as claimed in claim 26, further comprising:
a fourth port configured to be coupled to a second transceiver of the first network node; and
a second switch configured to:
couple the first port to the second port in a third mode and couple the second port to the fourth port in a fourth mode; and
utilize power supplied by the second transceiver to enter the fourth mode.

28. The ROADM as claimed in claim 26 wherein:
the first port comprises a first receiver port and a first transmitter port;
the second port comprises a second receiver port and a second transmitter port; and
the third port comprises a third receiver port and a third transmitter port.

29. The ROADM as claimed in claim 28, wherein the first switch comprises:
a first bi-stable switch which in the first mode couples the first transmitter port and the second receiver port; and
a second bi-stable switch which in the first mode couples the first receiver port and the second transmitter port.

30. The ROADM as claimed in claim 29, wherein the first switch further comprises switching circuitry configured to:
responsive to the first transceiver being on:
provide power to switch the first bi-stable switch to couple the first transmitter port and the third receiver port; and
provide power to switch the second bi-stable switch to couple the first receiver port and the third transmitter port.

31. The ROADM as claimed in claim 30, wherein the switching circuitry comprises an accumulator configured to charge whilst power is supplied at the third port.

32. The ROADM as claimed in claim 31 wherein the switching circuitry is configured to:
responsive to the first transceiver being switched off:
provide power from the accumulator to switch the first bi-stable switch to couple the first transmitter port and the second receiver port; and
provide power from the accumulator to switch the second bi-stable switch to couple the first receiver port and the second transmitter port.

33. The ROADM as claimed in claim 26, further comprising:
a first multiplexer/demultiplexer (MUX/DEMUX) module configured to multiplex signals received at a first plurality of ports comprising the first port; and
a second MUX/DEMUX configured to multiplex signals received at a second plurality of ports comprising the second port.

34. The ROADM as claimed in claim 33, wherein:
the first MUX/DEMUX module is configured to demultiplex signals received at one or more fifth ports for transmission over the first plurality of ports; and
the second MUX/DEMUX module is configured to demultiplex signals received at one or more sixth ports for transmission over the second plurality of ports.

35. The ROADM as claimed in claim 33, wherein the first Mux/DEMUX module comprises one or more of the following passive elements: an Arrayed Waveguide Grating, an N×M AWG, or a thin film filter (TFF).

36. The ROADM as claimed in claim 26, further comprising a photodetector configured to convert optical power from the first transceiver to electrical power to enter the second mode.

37. The ROADM as claimed in claim 36, wherein the first switch is configured to enter the second mode on detection of optical power from the first transceiver by the photodetector.

38. The ROADM as claimed in claim 26, wherein the ROADM comprises a two way ROADM or a multiple-way ROADM.

39. An optical network comprising the ROADM as claimed in claim 26.

40. A method of performing adding or dropping of signals at a reconfigurable optical add/drop multiplexer (ROADM), wherein the ROADM comprises a first port, a second port, a third port, and a switch, the method comprising:
responsive to receiving power at the third port, utilizing the power at the switch to couple the first port to the third port.

41. The method as claimed in claim 40, wherein utilizing the power at the switch to couple the first port to the third port comprises switching a bi-stable switch from a first position in which the first port is coupled to the second port to a second position in which the first port is coupled to the third port.

42. The method as claimed in claim 40, further comprising, responsive to receiving power at the third port, charging an accumulator in the switch with the power.

43. The method as claimed in claim 42, further comprising, responsive to power not being received at the third port, using the power stored at the accumulator to couple the first port to the second port.

44. The method as claimed in claim 40, wherein the third port is configured to be coupled to a first transceiver of a first network node, wherein the method further comprises:
coupling the first port to the second port in a first mode; and
coupling the first port to the third port in a second mode.
